(19) United States
(12) Patent Application Publication
(10) Pub. No.: US 2024/0357677 A1
(43) Pub. Date: Oct. 24, 2024

(54) DIRECT COMMAND AND CONTROL CONNECTION AUTHORIZATION

(71) Applicant: QUALCOMM Incorporated, San Diego, CA (US)

(72) Inventors: Stefano FACCIN, San Ysidro, CA (US); Sunghoon KIM, San Diego, CA (US)

(21) Appl. No.: 18/412,007

(22) Filed: Jan. 12, 2024

Related U.S. Application Data
(60) Provisional application No. 63/494,640, filed on Apr. 6, 2023.

(51) Int. Cl. H04W 76/14

(52) U.S. Cl. CPC H04W 76/14

(57) ABSTRACT

Various aspects of the present disclosure generally relate to wireless communication. In some aspects, a user equipment (UE) at an uncrewed aerial vehicle (UAV) or an aerial UE (AUE) may transmit a request message associated with a mobility management procedure, the request message including a command and control (C2) authorization payload associated with authorizing a direct C2 connection between the UAV and a controller. The UE at the UAV or the AUE may receive a response message, as part of the mobility management procedure, that indicates whether the direct C2 connection between the UAV and the controller is authorized. Numerous other aspects are described.

### CROSS-REFERENCE TO RELATED APPLICATION

This Patent application claims priority to U.S. Provisional Patent Application No. 63/494,640, filed on Apr. 6, 2023, entitled “DIRECT COMMAND AND CONTROL CONNECTION AUTHORIZATION,” and assigned to the assignee hereof. The disclosure of the prior application is considered part of and is incorporated by reference into this patent application.

### FIELD OF THE DISCLOSURE

Aspects of the present disclosure generally relate to wireless communication and to techniques and apparatuses for direct command and control connection authorization.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by a user equipment (UE) at an uncrewed aerial vehicle (UAV) or an aerial UE (AUE). The method may include transmitting a request message associated with a mobility management procedure, the request message including a command and control (C2) authorization payload associated with authorizing a direct C2 connection between the UAV and a controller. The method may include receiving a response message, as part of the mobility management procedure, that indicates whether the direct C2 connection between the UAV and the controller is authorized.

Some aspects described herein relate to a method of wireless communication performed by a network entity. The method may include receiving a request message associated with a mobility management procedure, the request message including a C2 authorization payload associated with authorizing a direct C2 connection between a UAV and a controller. The method may include transmitting a response message, as part of the mobility management procedure, that indicates whether the direct C2 connection between the UAV and the controller is authorized.

Some aspects described herein relate to a UE at a UAV or an AUE for wireless communication. The UE may include a memory and one or more processors coupled to the memory. The one or more processors may be configured to transmit a request message associated with a mobility management procedure, the request message including a C2 authorization payload associated with authorizing a direct C2 connection between the UAV and a controller. The one or more processors may be configured to receive a response message, as part of the mobility management procedure, that indicates whether the direct C2 connection between the UAV and the controller is authorized.

Some aspects described herein relate to a network entity for wireless communication. The network entity may include a memory and one or more processors coupled to the memory. The one or more processors may be configured to receive a request message associated with a mobility management procedure, the request message including a C2 authorization payload associated with authorizing a direct C2 connection between a UAV and a controller. The one or more processors may be configured to transmit a response message, as part of the mobility management procedure, that indicates whether the direct C2 connection between the UAV and the controller is authorized.

Some aspects described herein relate to a non-transitory computer-readable medium that stores a set of instructions for wireless communication by a UE at a UAV or an AUE. The set of instructions, when executed by one or more processors of the UE, may cause the UE to transmit a request message associated with a mobility management procedure, the request message including a C2 authorization payload associated with authorizing a direct C2 connection between the UAV and a controller. The set of instructions, when executed by one or more processors of the UE, may cause the UE to receive a response message, as part of the mobility management procedure, that indicates whether the direct C2 connection between the UAV and the controller is authorized.

Some aspects described herein relate to a non-transitory computer-readable medium that stores a set of instructions for wireless communication by a network entity. The set of instructions, when executed by one or more processors of the network entity, may cause the network entity to receive a request message associated with a mobility management procedure, the request message including a C2 authorization payload associated with authorizing a direct C2 connection between a UAV and a controller. The set of instructions, when executed by one or more processors of the network entity, may cause the network entity to transmit a response message, as part of the mobility management procedure, that indicates whether the direct C2 connection between the UAV and the controller is authorized.

Some aspects described herein relate to an apparatus at a UAV or an aerial apparatus for wireless communication. The apparatus may include means for transmitting a request message associated with a mobility management procedure, the request message including a C2 authorization payload associated with authorizing a direct C2 connection between the UAV and a controller. The apparatus may include means for receiving a response message, as part of the mobility management procedure, that indicates whether the direct C2 connection between the UAV and the controller is authorized.

Some aspects described herein relate to an apparatus for wireless communication. The apparatus may include means for receiving a request message associated with a mobility management procedure, the request message including a C2 authorization payload associated with authorizing a direct C2 connection between a UAV and a controller. The apparatus may include means for transmitting a response message, as part of the mobility management procedure, that indicates whether the direct C2 connection between the UAV and the controller is authorized.

Aspects generally include a method, apparatus, system, computer program product, non-transitory computer-readable medium, user equipment, base station, network entity, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example disaggregated base station architecture, in accordance with the present disclosure.

FIG. 4 is a diagram illustrating an example of uncrewed aerial vehicle (UAV) UEs within a wireless communication network environment, in accordance with the present disclosure.

FIG. 5 is a diagram illustrating an example of a registration procedure, in accordance with the present disclosure.

FIG. 6 is a diagram illustrating an example of an uncrewed aerial system service supplier UAV authorization and authentication mobility management procedure, in accordance with the present disclosure.

FIG. 7 is a diagram illustrating an example of using a mobility management procedure to authorize a direct command and control connection, in accordance with the present disclosure.

FIG. 8 is a diagram illustrating an example process performed, for example, by a UE at a UAV, in accordance with the present disclosure.

FIG. 9 is a diagram illustrating an example process performed, for example, by a network entity, in accordance with the present disclosure.

FIG. 10 is a diagram of an example apparatus for wireless communication, in accordance with the present disclosure.

FIG. 11 is a diagram of an example apparatus for wireless communication, in accordance with the present disclosure.

### DETAILED DESCRIPTION

An uncrewed aerial vehicle (UAV) may include an aircraft without a human pilot aboard and can also be referred to as an unmanned aircraft, a drone, a remotely piloted vehicle, a remotely piloted aircraft, or a remotely operated aircraft. The UAV may connect to a network entity such as an uncrewed aerial system (UAS) network function (UAS NF) in 5G core network. The UAS NF may connect to a UAS service supplier (USS) device that is capable of receiving, storing, processing, and/or providing information associated with at least one UAV user equipment (UE) and/or a ground control station (GCS).

Third Generation Partnership Project (3GPP) standard Release 18 adds the ability to support command and control (C2) communications over a sidelink (e.g., PC5) between a UAV and a UAV controller (UAV-C) or a GCS. A UAV may communicate with a UAV-C over PC5 via a direct C2 connection, either over broadcast or unicast communication. The C2 connection may be “direct” because the C2 communications are on a sidelink directly between the UAV UE and the UAV-C. A UAS traffic management (UTM) may be used to authorize the direct C2 connection using a C2 authorization payload from a UE at a UAV. At present, authorization for a direct C2 connection by the UTM/USS is supported via the use of a USS UAV authorization and authentication session management (UUAA-SM) procedure defined in 3GPP technical specification (TS) 23.256 v18.0.0 clause 5.2.3, which authorizes the establishment of a protocol data unit (PDU) session. That is, in order to authorize a direct C2 connection for a UAV that will be used to exchange C2 communications over PC5, the UE at the UAV is expected to establish a PDU session that is used for no other purpose. Moreover, the PDU session needs to be maintained in order to enable the UTM/USS to de-authorize the direct C2 connection. The otherwise unused PDU session is inefficient and wastes signaling resources.

According to various aspects described herein, a UAV may be configured to authorize a direct C2 connection without requiring the establishment of PDU sessions. The UAV may extend an existing mobility management procedure, such as a USS UAV authorization and authentication mobility management (UUAA-MM) procedure that is triggered for a UE that requires UAV authentication and authorization by a USS when registering with a 5G network, as described in clause 5.2.2.1 of 3GPP TS 23.256 v18.0.0. In some aspects, the UE at the UAV may include a C2 authorization payload in the registration request. The UAS NF may provide the C2 authorization payload to the serving UTM. Upon a successful mobility management procedure, the UE may be provided with an authorization response indicating authorization to use a direct C2 connection for direct C2 communications. The UE at the UAV may use a direct C2 connection over PC5 with a UAV-C. By providing the C2 authorization payload as part of a mobility management procedure (e.g., UUAA-MM procedure) rather than as part of a UUAA-SM procedure with an established PDU session, the UE may authorize a direct C2 connection without establishing and wasting PDU sessions. As a result, signaling resources are conserved.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

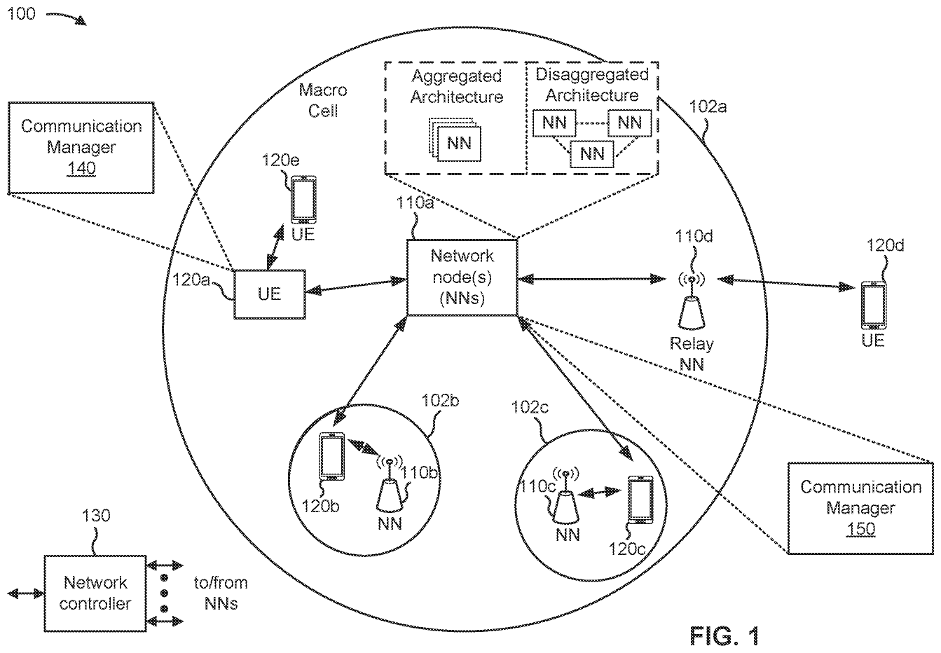

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a UE 120 or multiple UEs 120 (shown as a UE 120a, a UE 120b, a UE 120c, a UE 120d, and a UE 120c), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the 3GPP, the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (cMTC) UEs. An MTC UE and/or an eMTC UE may include, for example, a robot, a drone, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120c) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHZ) and FR2 (24.25 GHz-52.6 GHZ). It should be understood that although a portion of FR1 is greater than 6 GHZ, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHZ-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHZ-71 GHz), FR4 (52.6 GHz-114.25 GHZ), and FR5 (114.25 GHZ-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHZ, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, a UE (e.g., a UE 120) at a UAV (e.g., 120-1) or an aerial UE (AUE) (e.g., a UE 120 at altitude and not on the ground) may include a communication manager 140. As described in more detail elsewhere herein, the communication manager 140 may transmit a request message associated with a mobility management procedure, the request message including a C2 authorization payload associated with authorizing a direct C2 connection between the UAV and a controller. The communication manager 140 may receive a response message, as part of the mobility management procedure, that indicates whether the direct C2 connection between the UAV and the controller is authorized. Additionally, or alternatively, the communication manager 140 may perform one or more other operations described herein.

In some aspects, a network entity (e.g., a network node 110) may include a communication manager 150. As described in more detail elsewhere herein, the communication manager 150 may receive a request message associated with a mobility management procedure, the request message including a C2 authorization payload associated with authorizing a direct C2 connection between a UAV and a controller. The communication manager 150 may transmit a response message, as part of the mobility management procedure, that indicates whether the direct C2 connection between the UAV and the controller is authorized. Additionally, or alternatively, the communication manager 150 may perform one or more other operations described herein.

As indicated above, FIG. 1 is provided as an example. Other examples may differ from what is described with regard to FIG. 1.

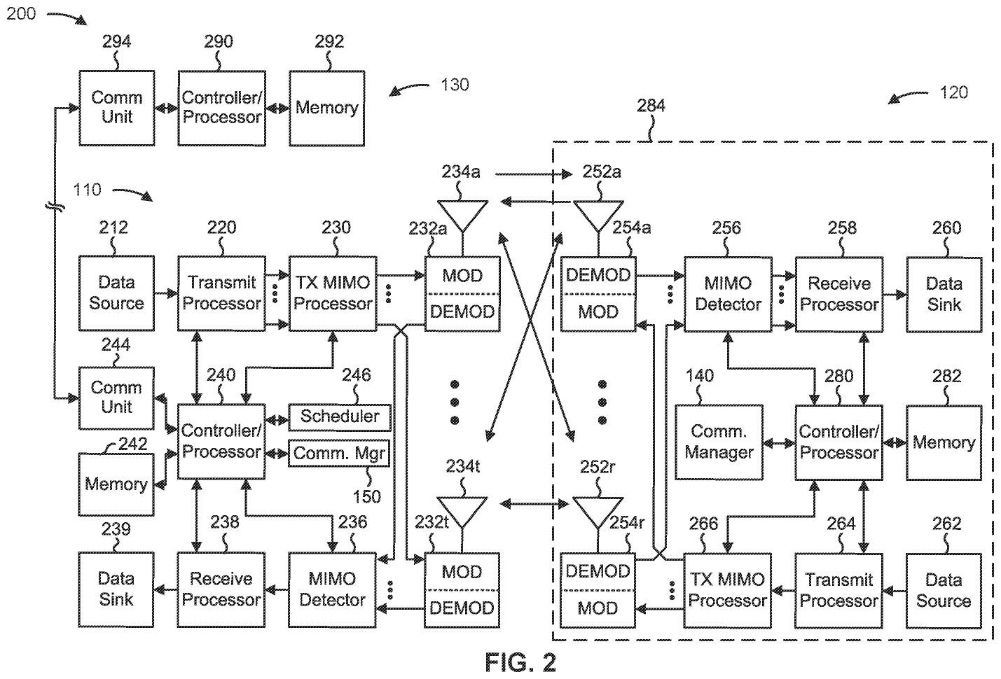

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 232. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

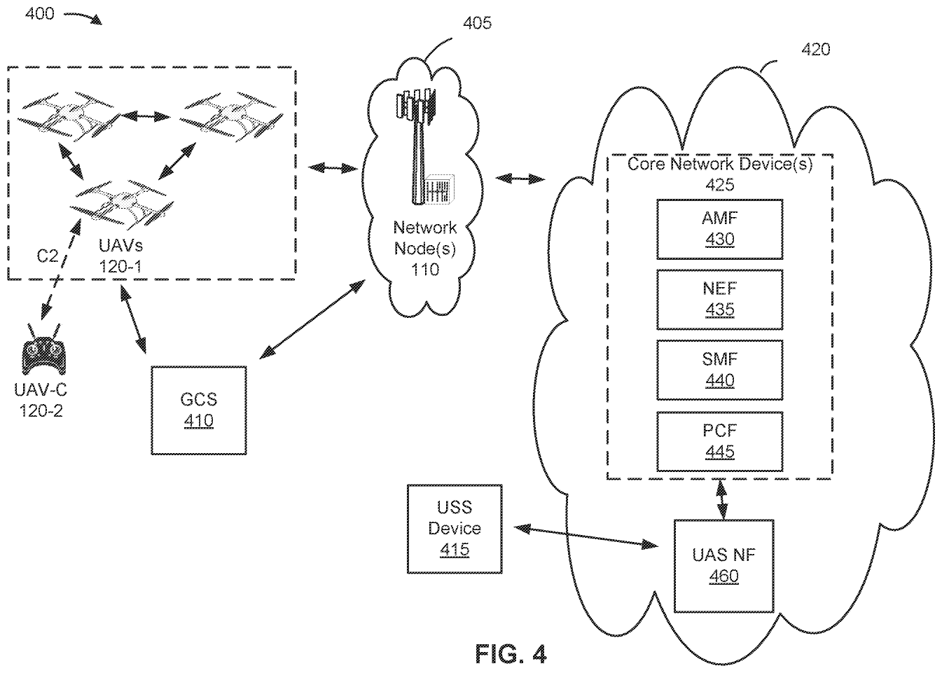

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 4-11).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 4-11).

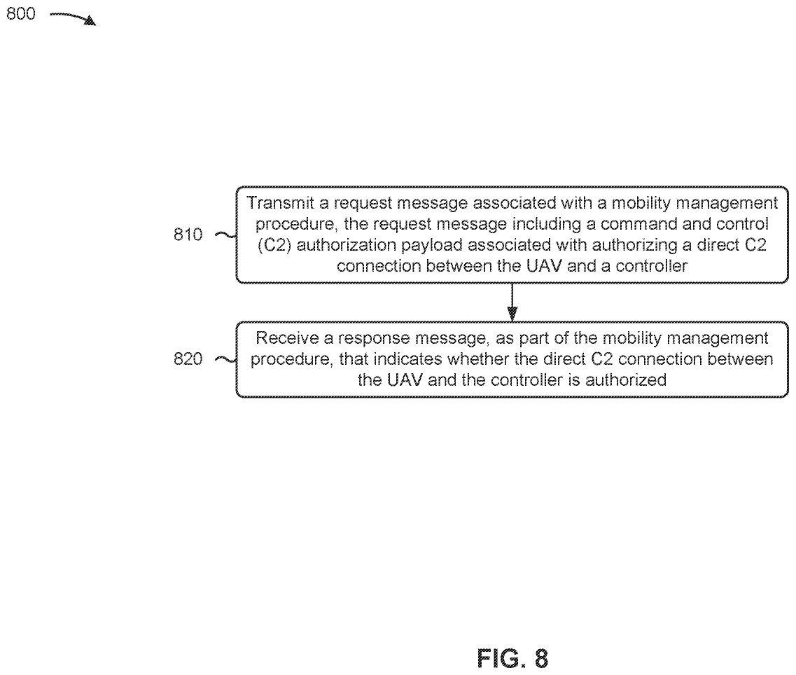

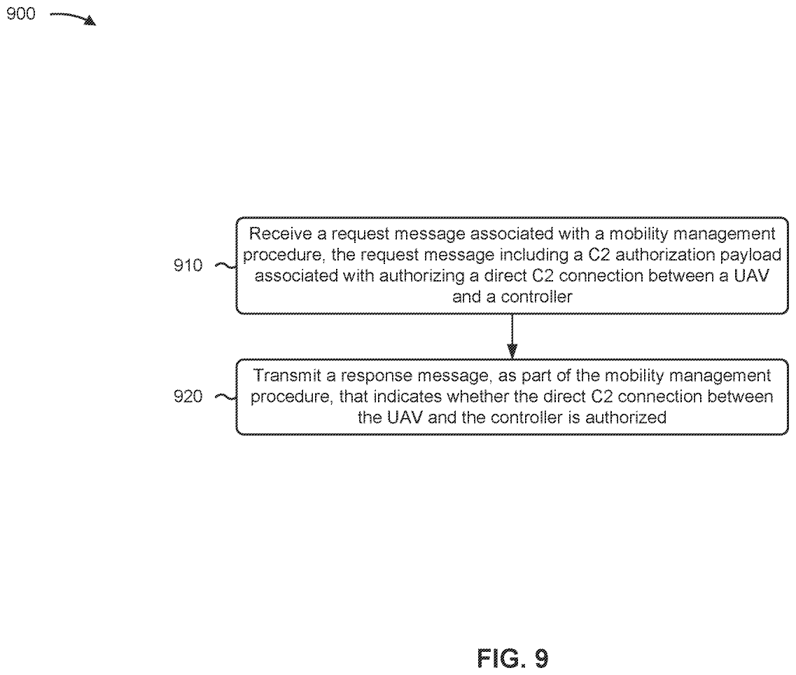

A controller/processor of a network entity (e.g., controller/processor 240 of the network node 110), the controller/processor 280 of the UE 120, and/or any other component(s) of FIG. 2 may perform one or more techniques associated with direct C2 connection authorization, as described in more detail elsewhere herein. For example, the controller/processor 240 of the network node 110, the controller/processor 280 of the UE 120, and/or any other component(s) of FIG. 2 may perform or direct operations of, for example, process 800 of FIG. 8, process 900 of FIG. 9, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 800 of FIG. 8, process 900 of FIG. 9, and/or other processes as described herein. In some examples, executing instructions may include running the instructions, converting the instructions, compiling the instructions, and/or interpreting the instructions, among other examples.

In some aspects, a UE (e.g., a UE 120) at a UAV or a UAE includes means for transmitting a request message associated with a mobility management procedure, the request message including a C2 authorization payload associated with authorizing a direct C2 connection between the UAV and a controller; and/or means for receiving a response message, as part of the mobility management procedure, that indicates whether the direct C2 connection between the UAV and the controller is authorized. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, a network entity (e.g., a network node 110) includes means for receiving a request message associated with a mobility management procedure, the request message including a C2 authorization payload associated with authorizing a direct C2 connection between a UAV and a controller; and/or means for transmitting a response message, as part of the mobility management procedure, that indicates whether the direct C2 connection between the UAV and the controller is authorized. In some aspects, the means for the network entity to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (CNB), an NR base station, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

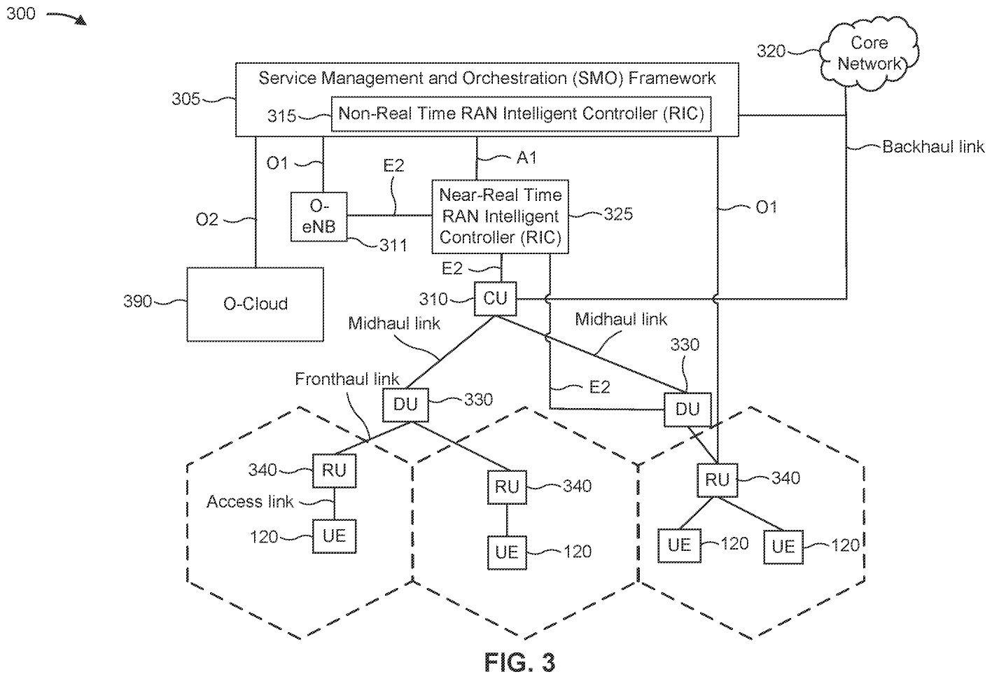

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUs 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (IFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

As indicated above, FIG. 3 is provided as an example. Other examples may differ from what is described with regard to FIG. 3.

FIG. 4 is a diagram illustrating an example of UAV UEs 120 within a wireless communication network environment 400, in accordance with the present disclosure. As shown in FIG. 4, the environment 400 can include one or more UEs 120, which may include one or more UAVs 120-1 and one or more UAV-Cs 120-2, a RAN 405, a core network 420, a USS device 415, and a GCS 410. Devices of environment 400 can interconnect via wired connections, wireless connections, or a combination of wired and wireless connections.

The UAV 120-1 (also referred to herein as a UAV UE 120-1) may include an aircraft without a human pilot aboard and can also be referred to as an unmanned aircraft (UA), a drone, a remotely piloted vehicle (RPV), a remotely piloted aircraft (RPA), a remotely operated aircraft (ROA), or an uncrewed aerial vehicle. The UAV 120-1 may have a variety of shapes, sizes, configurations, characteristics, or the like for a variety of purposes and applications. In some examples, the UAV 120-1 may include one or more sensors, such as an electromagnetic spectrum sensor (e.g., a visual spectrum, infrared, or near infrared camera, a radar system, or the like), a biological sensor, a temperature sensor, and/or a chemical sensor, among other examples. In some examples, the UAV 120-1 may include one or more components for communicating with one or more network nodes 110. Additionally, or alternatively, the UAV 120-1 may transmit information to and/or receive information from the GCS 410, such as sensor data, flight plan information, or the like. Such information can be communicated directly (e.g., via an RRC signal and/or the like) and/or via the network node(s) 110 on the RAN 405. The UAV 120-1 may be a component of an unmanned aircraft system (UAS). The UAS may include the UAV 120-1, a UAV-C 120-2 (also referred to herein as a UAV-C UE 120-2), and a system of communication (such as wireless network environment 400 or another system of communication) between the UAV 120-1 and the UAV-C 120-2.

The RAN 405 may include one or more network nodes 110 that provide access for the UAV UEs 120 to the core network 420. For example, the RAN 405 may include one or more aggregated network nodes and/or one or more disaggregated network nodes (e.g., including one or more CUs, one or more DUs, and/or one or more RUs). The UAV 120-1 may communicate with the network nodes 110 via the Uu interface. For example, the UAV 120-1 may transmit communications to a network node 110 and/or receive communications from the network node 110 via the Uu interface. Such Uu connectivity may be used to support different applications for the UAV 120-1, such as video transmission from the UAV 120-1 or C2 communications for remote command and control of the UAV 120-1, among other examples.

The GCS 410 may include one or more devices capable of managing the UAV 120-1 and/or flight plans for the UAV 120-1. For example, the GCS 410 may include a server device, a desktop computer, a laptop computer, or a similar device. In some examples, the GCS 410 may communicate with one or more devices of the environment 400 (e.g., the UAV 120-1, the USS device 415, and/or the like) to receive information regarding flight plans for the UAV UEs 120-1 and/or to provide recommendations associated with such flight plans, as described elsewhere herein. In some examples, the GCS 410 may permit a user to control one or more of the UAVs 120-1 (e.g., via the UAV-C 120-2). Additionally, or alternatively, the GCS 410 can use a neural network and/or other artificial intelligence (AI) to control one or more of the UAVs 120-1. In some examples, the GCS 410 may be included in a data center, a cloud computing environment, a server farm, or the like, which may include multiple GCSs 410. While shown as being external from the core network 420 in FIG. 4, in some aspects, the GCS 410 may reside at least partially within the core network 420.

The USS device 415 includes one or more devices capable of receiving, storing, processing, and/or providing information associated with the UAV UEs 120 and/or the GCS 410. For example, the USS device 415 can include an application server, a desktop computer, a laptop computer, a tablet computer, a mobile phone, or a similar device. In some examples, the UAVs 120-1 can interact with the USS device 415 to register a flight plan, receive approval, analysis, and/or recommendations related to a flight plan, or the like. The USS device 415 may register the UAV UE 120 with the USS device 415 by assigning an application-level UAV identifier to the UAV UE 120. The application-level UAV identifier may be an aviation administration (e.g., a regulatory body that governs aviation operation in a jurisdiction in which the USS device 415 and the UAV UE 120 are operating) UAV identifier.

The core network 420 includes a network that enables communications between the RAN 405 (e.g., the network node(s) 110) and one or more devices and/or networks connected to the core network 420. For example, the core network 420 may be a 5G core network. The core network 420 may include one or more core network devices 425, such as one or more access and mobility management functions (AMFs) (herein after referred to as an “AMF”) 430, one or more network exposure functions (NEFs) herein after referred to as an “NEF”) 435, one or more session management functions (SMFs) (herein after referred to as an “SMF”) 440, one or more policy control functions (PCFs) (herein after referred to as a “PCF”) 445, and/or other entities and/or functions that provide mobility functions for the UAV UEs 120 and enable the UAV UEs 120 to communicate with other devices of the environment 400.

The AMF 430 may include one or more network devices, such as one or more server devices, capable of managing authentication, activation, deactivation, and/or mobility functions associated with the UAV UE 120 connected to the core network 420. In some examples, the AMF 430 may perform operations relating to authentication of the UAV 120-1. The AMF 430 may maintain a non-access stratum (NAS) signaling connection with the UAV 120-1.

The NEF 435 may include one or more network exposure devices, such as one or more server devices, capable of exposing capabilities, events, information, or the like in one or more wireless networks to help other devices in the one or more wireless networks discover network services and/or utilize network resources efficiently. In some examples, the NEF 435 may receive traffic from and/or send traffic to the UAV 120-1 via the AMF 430 and the network node 110, and the NEF 435 may receive traffic from and/or send traffic to the USS device 415 via a UAS NF 460. In some examples, the NEF 435 may obtain a data structure, such as approval of a flight plan for the UAV 120-1, from the USS device 415 and divide the data structure into a plurality of data segments. In some examples, the NEF 435 may determine a location and/or reachability of the UAV 120-1 and/or a communication capability of the network node 110 to determine how to send the plurality of data segments to the UAV 120-1.

The SMF 440 may include one or more network devices, such as one or more server devices, capable of managing sessions for the RAN 405 and allocating addresses, such as Internet protocol (IP) addresses, to the UAVs 120-1. In some examples, the SMF 440 may perform operations relating to registration of the UAV 120-1. For example, the AMF 430 may receive a registration request from the UAV 120-1 and forward a request to the SMF 440 to create a corresponding PDU session. The SMF 440 may allocate an address to the UAV 120-1 and establish the PDU session for the AMF 430.

The PCF 445 may include one or more network devices, such as one or more server devices, capable of managing traffic to and from the UAV UEs 120 through the RAN 405 and enforcing a quality of service (QOS) on the RAN 405. In some examples, the PCF 445 may implement charging rules and flow control rules, manage traffic priority, and/or manage a QoS for the UAVs 120-1.

The USS device 415 may communicate with the core network 420 using the UAS NF 460. The UAS NF 460 may be a service-based interface to enable the USS device 415 to provide information to the core network 420. For example, the USS device 415 may provide, via the UAS NF 460, registration information associated with a registration between the UAV 120-1 and the USS device 415. The UAS NF 460 may include a device, such as a server device, that is external to the core network 420, or the UAS NF 460 may reside, at least partially, on a core network device 425 within the core network 420. In some aspects, the UAS NF 460 may be co-located with the NEF 435. In some aspects, or more of the core network device(s) 425 and/or the UAS NF 460 may correspond to network controller 130, as described above in connection with FIG. 1.

The UAV-C 120-2 may remotely control the UAV 120-2 by transmitting C2 communications to the UAV 120-1 and/or receiving C2 communications from the UAV 120-1. In some examples, the UAV-C 120-2 and the UAV 120-1 may use the Uu interface for the C2 communications. For example, the UAV-C 120-2 may transmit C2 communications to UAV 120-1 (and receive C2 communications from the UAV 120-1) via the network node 110. In some examples, the UAV-C 120-2 and the UAV 120-1 may use a non-cellular communication system (e.g., non-3GPP connectivity), such as wireless fidelity (Wi-Fi), for the C2 communications. Currently, NR, in the specification promulgated by 3GPP, does not support transmission of C2 communications via the PC5 interface. However, in some cases, the UAV-C 120-2 may be capable of communicating via the PC5 interface but may not have Uu capability. Furthermore, because PC5 can cover a longer distance than Wi-Fi, transmission of C2 communications via PC5 unicast communications may result in an increased range of the C2 communications, as compared with Wi-Fi. In addition, transmission of C2 communications via PC5 unicast communications (e.g., via a PC5 direct link between the UAV 120-1 and the UAV-C 120-2) may result in decreased latency, as compared with C2 communications transmitted via the network node 110 using the Uu interface.

3GPP standard Release 18 adds the ability to support C2 communications over PC5 (a direct C2 connection) between a UAV and a UAV-C or GCS. At present, authorization for a direct C2 connection by the UTM/USS or an external application function (AF, such as the UAS operator) is supported via the use of a UUAA-SM procedure defined in 3GPP TS 23.256 v18.0.0 clause 5.2.3, which authorizes the establishment of a PDU session. That is, in order to authorize a direct C2 connection for a UAV that will be used to exchange C2 communications over PC5, the UAV is expected to establish a PDU session that is otherwise used for no other purpose. Moreover, the PDU session needs to be maintained in order to enable the UTM/USS to de-authorize the direct C2 connection. This is inefficient and wastes signaling resources.

As indicated above, FIG. 4 is provided as an example. Other examples may differ from what is described with respect to FIG. 4.

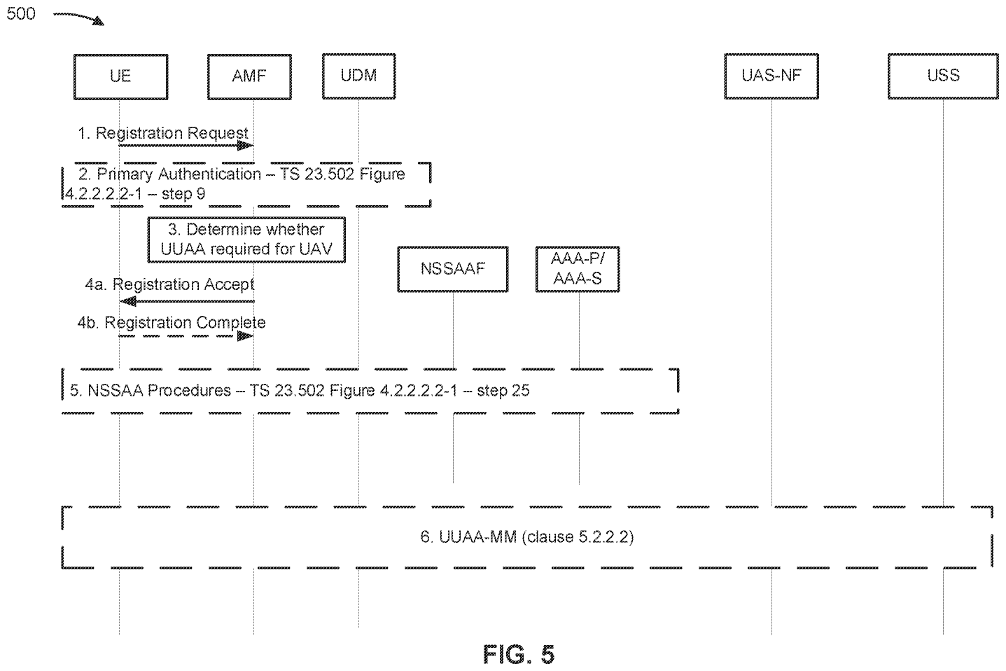

FIG. 5 is a diagram illustrating an example 500 of a registration procedure, in accordance with the present disclosure.

Example 500 shows a UUAA-MM procedure that is triggered for a UE that requires UAV authentication and authorization by a USS when registering with a 5G network, as described in clause 5.2.2.1 of 3GPP TS 23.256 v18.0.0. The UE is authenticated and authorized by the USS using a civil aviation administration (CAA)-level UAV identifier (ID) and credentials associated with the CAA-Level UAV ID, different from the 3GPP subscription credentials. During the UUAA-MM procedure, the AMF communicates with the USS via a UAS NF and forwards authentication messages transparently between the UE and UAS NF.

As shown in step 1 of example 500, the UE may send a registration request message. In step 2, if primary authentication is expected, the AMF invokes authentication. Subsequently, the AMF retrieves UE subscription data from the UDM. In step 3, the AMF may determine whether a UUAA-MM procedure is required for the UAV. For example, the AMF may decide that UUAA is required if the UE has valid aerial UE subscription information, UUAA is to be performed during registration according to local operator policy, there is no successful UUAA result from a previous UUAA-MM procedure, or the UE has provided a CAA-Level UAV ID.

In step 4a, if the AMF determines that a UUAA-MM procedure is to be performed, the AMF may include a pending UUAA-MM indication in a registration accept message. In step 4b, the AMF may receive a registration complete message. In step 5, if the UE indicates its support for a network slice-specific authentication and authorization (NSSAA) procedure in the UE MM core network capability. In step 6, if single network slice selection assistance information (S-NSSAI) that is associated with the UAS services is part of an allowed NSSAI, the UUAA-MM procedure is executed at this step. Once the UUAA-MM procedure is successfully completed for the UAV, the AMF stores a successful UUAA result and updates the UE context indicating that UUAA is no longer pending and the authorized CAA-Level UAV ID is provided by the USS. The USS may provide a new CAA-Level UAV ID as the authorized CAA-Level UAV ID. The AMF may trigger a UE Configuration Update procedure to deliver the UUAA result, the UUAA authorization payload containing UAV configuration and the authorized CAA-Level UAV ID if received from the USS to the UE.

As indicated above, FIG. 5 is provided as an example. Other examples may differ from what is described with regard to FIG. 5.

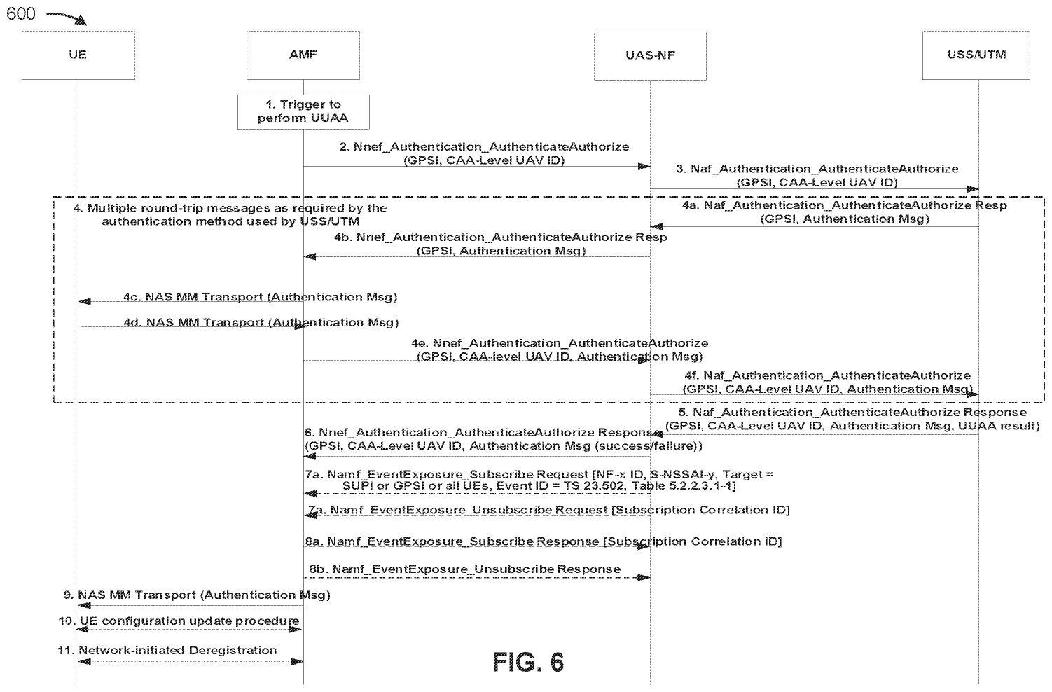

FIG. 6 is a diagram illustrating an example 600 of the UUAA-MM procedure, in accordance with the present disclosure.

For a UE that requires UUAA or when triggered by re-authentication by USS, the AMF may trigger a UUAA-MM procedure, as shown by step 1 in example 600. In step 2, the AMF may transmit an Nnef_Authentication_AuthenticateAuthorize request message to the UAS NF. The UAS NF may store the serving AMF ID. In step 3, the UAS NF may transmit an Naf_Authentication_AuthenticateAuthorize request message to the USS/UTM. The UAS NF/NEF may also provide a notification endpoint to the USS, so that the USS can include this notification endpoint together with UUAA updated parameters. By providing the notification endpoint, the UAS NF/NEF is implicitly subscribed to be notified of re-authentication, update authorization data, or revocation of UAV from USS, if the UUAA result is successful in step 5. In step 4 (steps 4a-4f), the USS/UTM may transmit Naf_Authentication_AuthenticateAuthorize response messages and include an authentication message.

In step 5, the USS/UTM may transmit an Naf_Authentication_Authenticate-Authorize response message that may include a UUAA result (success/failure) for the UAV and the UAS NF and an authorized/new CAA-Level UAV ID for the UAV, a UUAA authorization payload to the UAV (e.g., security information to be used to secure communications with USS), and a final authentication message (e.g. indicating success or failure, and if the UUAA is for re-authentication). In step 6, the UAS NF/NEF may transmit an Nnef_Authentication_AuthenticateAuthorize response message to the AMF.

In step 7a, the UAS NF/NEF may transmit to the AMF whether the UUAA-MM procedure succeeded. In step 8 (steps 8a-8b), the AMF may transmit an Namf_EventExposure_Subscribe response with a subscription correlation ID. In step 9, the AMF may transmit an NAS MM transport message forwarding authentication message from the USS, including an authentication/authorization result (success/failure), to the UE. In step 10, if the UUAA-MM procedure succeeded, the AMF may trigger a UE configuration update procedure to deliver to the UAV authorization information from the USS. In step 11, if the UUAA-MM procedure fails during a re-authentication and re-authorization and there are PDU session(s) established using UAS services, and the USS has indicated that the network resources can be released, the AMF may trigger the PDU sessions' release.

As indicated above, FIG. 6 is provided as an example. Other examples may differ from what is described with regard to FIG. 6.

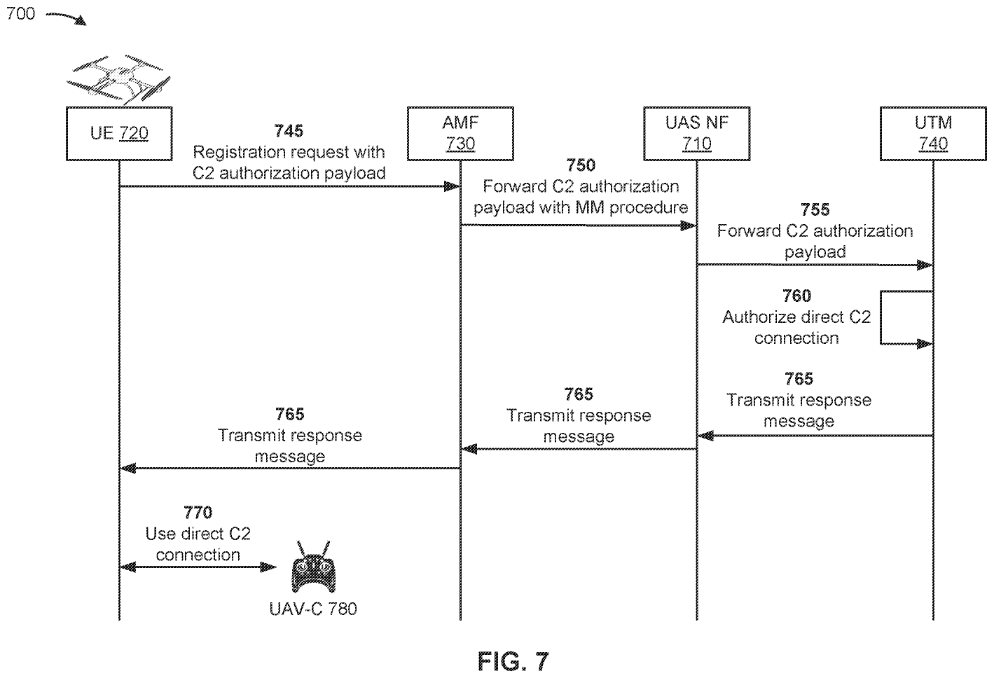

FIG. 7 is a diagram illustrating an example 700 of using a mobility management procedure to authorize a direct C2 connection, in accordance with the present disclosure. As shown in FIG. 7, a network entity such as a UAS NF 710 (e.g., UAS NF 460) may communicate with a UE 720 (e.g., a UE 120) via an AMF 730 (e.g., AMF 430). The UAS NF 710 may communicate with a UTM 740.

According to various aspects described herein, a UAV may be configured to authorize a direct C2 connection without requiring the establishment of PDU sessions. The UAV may extend an existing mobility management (e.g., UUAA-MM) procedure, performed upon registration, to authorize the direct C2 connection. In some aspects, the UE 720 at the UAV may include a C2 authorization payload in the registration request, as shown by reference number 745. The C2 authorization payload may include application layer information (e.g., UAV-C information) in order to obtain authorization for the direct C2 connection. The AMF 730, as shown by reference number 750, may perform the mobility management (MM) procedure (e.g., UUAA-MM procedure as described in connection with FIG. 6) and forward the C2 authorization payload to the UAS NF 710. The UAS NF 710 may provide the C2 authorization payload to the serving UTM 740, as shown by reference number 755. As shown by reference number 760, the UTM 740 may authorize a direct C2 connection. Upon a successful MM procedure, the UE 720 may be provided with an authorization response message indicating authorization to use a direct C2 connection for direct C2 communications, as shown by reference number 765. As shown by reference number 770, the UE 720 of the UAV may use a direct C2 connection over PC5 with a UAV-C 780. In summary, an MM procedure (e.g., UUAA-MM procedure) previously used only for network registration and authentication may enable the UAV to provide a CAA-specific UAV ID and the C2 authorization payload at the time of registration.

In some aspects, the UAV may also provide a C2 authorization payload recipient address (e.g., uniform resource locator (URL) or IP address) to identify an entity (e.g., UAS operator) responsible for authorizing the direct C2 connection. If the UAV provides such information, the UAS NF 710 may forward the information to the UTM 740 for UUAA authorization. The UTM 740 may also authorize the information in the C2 authorization payload, and the entity identified by the C2 authorization payload recipient address can perform direct C2 communications for the UAV.

Upon a successful response from the UTM 740, the UAS NF 710 may forward the C2 authorization payload to the entity identified by the C2 authorization payload recipient address for direct C2 authorization. In some aspects, if the authorization request for a direct C2 connection is included in the registration request and the C2 authorization is successful, the UTM 740 (USS) may include direct C2 pairing information containing the UAV-C's Application Layer ID in a C2 authorization payload (e.g., C2 aviation payload) that is forwarded to the UE 720 in the Naf_Authentication_Authenticate-Authorize response.

In some aspects, the UE 720 may transmit an updated request message with an updated C2 authorization payload. The UAS NF 710 may transmit an updated response message that indicates whether the direct C2 connection between the UAV and the UAV-C 780 is still authorized or is reauthorized.

By providing the C2 authorization payload as part of an MM procedure (e.g., UUAA-MM procedure) rather than as part of a UUAA-SM procedure with an established PDU session, the UE 720 may authorize or reauthorize a direct C2 connection without establishing and wasting PDU sessions. As a result, signaling resources are conserved.

As indicated above, FIG. 7 is provided as an example. Other examples may differ from what is described with regard to FIG. 7.

FIG. 8 is a diagram illustrating an example process 800 performed, for example, by a UE at a UAV (e.g., UE 120-1) or a AUE, in accordance with the present disclosure. Example process 800 is an example where the UE (e.g., UE 120, UE 720) performs operations associated with direct C2 connection authorization.

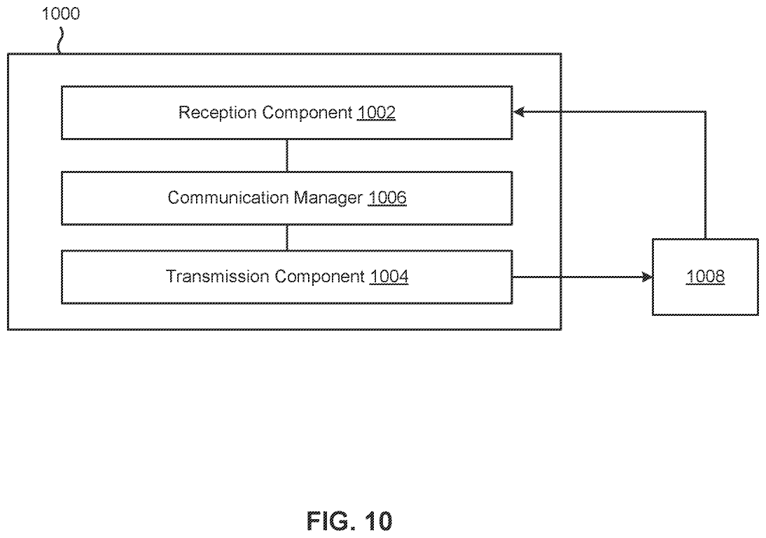

As shown in FIG. 8, in some aspects, process 800 may include transmitting a request message associated with a mobility management procedure, the request message including a C2 authorization payload associated with authorizing a direct C2 connection between the UAV and a controller (block 810). For example, the UE (e.g., using transmission component 1004 and/or communication manager 1006, depicted in FIG. 10) may transmit a request message associated with a mobility management procedure, the request message including a C2 authorization payload associated with authorizing a direct C2 connection between the UAV and a controller, as described above.

As further shown in FIG. 8, in some aspects, process 800 may include receiving a response message, as part of the mobility management procedure, that indicates whether the direct C2 connection between the UAV and the controller is authorized (block 820). For example, the UE (e.g., using reception component 1002 and/or communication manager 1006, depicted in FIG. 10) may receive a response message, as part of the mobility management procedure, that indicates whether the direct C2 connection between the UAV and the controller is authorized, as described above.

Process 800 may include additional aspects, such as any single aspect or any combination of aspects described below and/or in connection with one or more other processes described elsewhere herein.

In a first aspect, the direct C2 connection is a PC5 connection.

In a second aspect, alone or in combination with the first aspect, the mobility management procedure includes a UUAA-MM procedure.

In a third aspect, alone or in combination with one or more of the first and second aspects, the C2 authorization payload is a C2 aviation payload that indicates that the authorization is for the direct C2 connection.

In a fourth aspect, alone or in combination with one or more of the first through third aspects, the request message includes a destination address for an authorization server.

In a fifth aspect, alone or in combination with one or more of the first through fourth aspects, the C2 authorization payload includes C2 pairing information for the direct C2 connection.

In a sixth aspect, alone or in combination with one or more of the first through fifth aspects, the response message indicates a successful authorization of the direct C2 connection and includes an application layer ID.

In a seventh aspect, alone or in combination with one or more of the first through sixth aspects, process 800 includes transmitting an updated request message with an updated C2 authorization payload, and receiving an updated response message that indicates whether the direct C2 connection between the UAV and the controller is still authorized or is reauthorized.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram illustrating an example process 900 performed, for example, by a network entity, in accordance with the present disclosure. Example process 900 is an example where the network entity (e.g., network node 110, UAS NF 710) performs operations associated with direct C2 connection authorization.

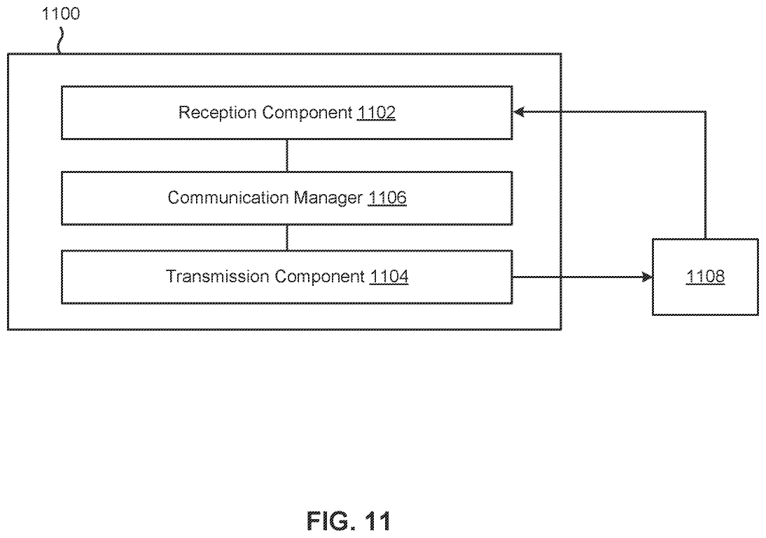

As shown in FIG. 9, in some aspects, process 900 may include receiving a request message associated with a mobility management procedure, the request message including a C2 authorization payload associated with authorizing a direct C2 connection between a UAV and a controller (block 910). For example, the network entity (e.g., using reception component 1102 and/or communication manager 1106, depicted in FIG. 11) may receive a request message associated with a mobility management procedure, the request message including a C2 authorization payload associated with authorizing a direct C2 connection between a UAV and a controller, as described above.

As further shown in FIG. 9, in some aspects, process 900 may include transmitting a response message, as part of the mobility management procedure, that indicates whether the direct C2 connection between the UAV and the controller is authorized (block 920). For example, the network entity (e.g., using transmission component 1104 and/or communication manager 1106, depicted in FIG. 11) may transmit a response message, as part of the mobility management procedure, that indicates whether the direct C2 connection between the UAV and the controller is authorized, as described above.

Process 900 may include additional aspects, such as any single aspect or any combination of aspects described below and/or in connection with one or more other processes described elsewhere herein.

In a first aspect, the direct C2 connection is a PC5 connection.

In a second aspect, alone or in combination with the first aspect, the C2 authorization payload is a C2 aviation payload that indicates that the authorization is for the direct C2 connection.

In a third aspect, alone or in combination with one or more of the first and second aspects, the C2 authorization payload includes C2 pairing information for the direct C2 connection.

In a fourth aspect, alone or in combination with one or more of the first through third aspects, the response message indicates a successful authorization of the direct C2 connection and includes an application layer ID.

In a fifth aspect, alone or in combination with one or more of the first through fourth aspects, process 900 includes forwarding the request message to a UTM component and receiving an authorization response from the UTM.

In a sixth aspect, alone or in combination with one or more of the first through fifth aspects, the request message includes a destination address for an authorization server, and process 900 includes forwarding the request message to the authorization server and receiving an authorization response from the authorization server.

In a seventh aspect, alone or in combination with one or more of the first through sixth aspects, transmitting the response message includes transmitting the response to a UE at the UAV via an AMF.

In an eighth aspect, alone or in combination with one or more of the first through seventh aspects, process 900 includes receiving an updated request message with an updated C2 authorization payload, and transmitting an updated response message that indicates whether the direct C2 connection between the UAV and the controller is still authorized or is reauthorized.

In a ninth aspect, alone or in combination with one or more of the first through eighth aspects, the network entity includes a UAS NF.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram of an example apparatus 1000 for wireless communication, in accordance with the present disclosure. The apparatus 1000 may be a UE (e.g., UE 120, UE 720) at a UAV (e.g., UE 120-1) or a AUE, or a UE may include the apparatus 1000. In some aspects, the apparatus 1000 includes a reception component 1002, a transmission component 1004, and/or a communication manager 1006, which may be in communication with one another (for example, via one or more buses and/or one or more other components). In some aspects, the communication manager 1006 is the communication manager 140 described in connection with FIG. 1. As shown, the apparatus 1000 may communicate with another apparatus 1008, such as a UE or a network node (such as a CU, a DU, an RU, or a base station), using the reception component 1002 and the transmission component 1004.

In some aspects, the apparatus 1000 may be configured to perform one or more operations described herein in connection with FIGS. 1-7. Additionally, or alternatively, the apparatus 1000 may be configured to perform one or more processes described herein, such as process 800 of FIG. 8. In some aspects, the apparatus 1000 and/or one or more components shown in FIG. 10 may include one or more components of the UE described in connection with FIG. 2. Additionally, or alternatively, one or more components shown in FIG. 10 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1002 may receive communications, such as reference signals, control information, data communications, or a combination thereof, from the apparatus 1008. The reception component 1002 may provide received communications to one or more other components of the apparatus 1000. In some aspects, the reception component 1002 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1000. In some aspects, the reception component 1002 may include one or more antennas, a modem, a demodulator, a MIMO detector, a receive processor, a controller/processor, a memory, or a combination thereof, of the UE described in connection with FIG. 2.

The transmission component 1004 may transmit communications, such as reference signals, control information, data communications, or a combination thereof, to the apparatus 1008. In some aspects, one or more other components of the apparatus 1000 may generate communications and may provide the generated communications to the transmission component 1004 for transmission to the apparatus 1008. In some aspects, the transmission component 1004 may perform signal processing on the generated communications (such as filtering, amplification, modulation, digital-to-analog conversion, multiplexing, interleaving, mapping, or encoding, among other examples), and may transmit the processed signals to the apparatus 1008. In some aspects, the transmission component 1004 may include one or more antennas, a modem, a modulator, a transmit MIMO processor, a transmit processor, a controller/processor, a memory, or a combination thereof, of the UE described in connection with FIG. 2. In some aspects, the transmission component 1004 may be co-located with the reception component 1002 in a transceiver.

The communication manager 1006 may support operations of the reception component 1002 and/or the transmission component 1004. For example, the communication manager 1006 may receive information associated with configuring reception of communications by the reception component 1002 and/or transmission of communications by the transmission component 1004. Additionally, or alternatively, the communication manager 1006 may generate and/or provide control information to the reception component 1002 and/or the transmission component 1004 to control reception and/or transmission of communications.

The transmission component 1004 may transmit a request message associated with a mobility management procedure, the request message including a C2 authorization payload associated with authorizing a direct C2 connection between the UAV and a controller. The reception component 1002 may receive a response message, as part of the mobility management procedure, that indicates whether the direct C2 connection between the UAV and the controller is authorized.

The transmission component 1004 may transmit an updated request message with an updated C2 authorization payload.

The reception component 1002 may receive an updated response message that indicates whether the direct C2 connection between the UAV and the controller is still authorized or is reauthorized.

The number and arrangement of components shown in FIG. 10 are provided as an example. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Additionally, or alternatively, a set of (one or more) components shown in FIG. 10 may perform one or more functions described as being performed by another set of components shown in FIG. 10.

FIG. 11 is a diagram of an example apparatus 1100 for wireless communication, in accordance with the present disclosure. The apparatus 1100 may be a network entity (e.g., network node 110, UAS NF 710), or a network entity may include the apparatus 1100. In some aspects, the apparatus 1100 includes a reception component 1102, a transmission component 1104, and/or a communication manager 1106, which may be in communication with one another (for example, via one or more buses and/or one or more other components). In some aspects, the communication manager 1106 is the communication manager 150 described in connection with FIG. 1. As shown, the apparatus 1100 may communicate with another apparatus 1108, such as a UE or a network node (such as a CU, a DU, an RU, or a base station), using the reception component 1102 and the transmission component 1104.

In some aspects, the apparatus 1100 may be configured to perform one or more operations described herein in connection with FIGS. 1-7. Additionally, or alternatively, the apparatus 1100 may be configured to perform one or more processes described herein, such as process 900 of FIG. 9. In some aspects, the apparatus 1100 and/or one or more components shown in FIG. 11 may include one or more components of the network entity described in connection with FIG. 2. Additionally, or alternatively, one or more components shown in FIG. 11 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1102 may receive communications, such as reference signals, control information, data communications, or a combination thereof, from the apparatus 1108. The reception component 1102 may provide received communications to one or more other components of the apparatus 1100. In some aspects, the reception component 1102 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1100. In some aspects, the reception component 1102 may include one or more antennas, a modem, a demodulator, a MIMO detector, a receive processor, a controller/processor, a memory, or a combination thereof, of the network entity described in connection with FIG. 2.

The transmission component 1104 may transmit communications, such as reference signals, control information, data communications, or a combination thereof, to the apparatus 1108. In some aspects, one or more other components of the apparatus 1100 may generate communications and may provide the generated communications to the transmission component 1104 for transmission to the apparatus 1108. In some aspects, the transmission component 1104 may perform signal processing on the generated communications (such as filtering, amplification, modulation, digital-to-analog conversion, multiplexing, interleaving, mapping, or encoding, among other examples), and may transmit the processed signals to the apparatus 1108. In some aspects, the transmission component 1104 may include one or more antennas, a modem, a modulator, a transmit MIMO processor, a transmit processor, a controller/processor, a memory, or a combination thereof, of the network entity described in connection with FIG. 2. In some aspects, the transmission component 1104 may be co-located with the reception component 1102 in a transceiver.

The communication manager 1106 may support operations of the reception component 1102 and/or the transmission component 1104. For example, the communication manager 1106 may receive information associated with configuring reception of communications by the reception component 1102 and/or transmission of communications by the transmission component 1104. Additionally, or alternatively, the communication manager 1106 may generate and/or provide control information to the reception component 1102 and/or the transmission component 1104 to control reception and/or transmission of communications.

The reception component 1102 may receive a request message associated with a mobility management procedure, the request message including a C2 authorization payload associated with authorizing a direct C2 connection between a UAV and a controller. The transmission component 1104 may transmit a response message, as part of the mobility management procedure, that indicates whether the direct C2 connection between the UAV and the controller is authorized.

The communication manager 1106 may forward the request message to a UTM component. The reception component 1102 may receive an authorization response from the UTM.

The reception component 1102 may receive an updated request message with an updated C2 authorization payload. The transmission component 1104 may transmit an updated response message that indicates whether the direct C2 connection between the UAV and the controller is still authorized or is reauthorized.

The number and arrangement of components shown in FIG. 11 are provided as an example. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components. Additionally, or alternatively, a set of (one or more) components shown in FIG. 11 may perform one or more functions described as being performed by another set of components shown in FIG. 11.

The following provides an overview of some Aspects of the present disclosure:

Aspect 1: A method of wireless communication performed by a user equipment (UE) at an uncrewed aerial vehicle (UAV) or an aerial UE, comprising: transmitting a request message associated with a mobility management procedure, the request message including a command and control (C2) authorization payload associated with authorizing a direct C2 connection between the UAV and a controller; and receiving a response message, as part of the mobility management procedure, that indicates whether the direct C2 connection between the UAV and the controller is authorized.

Aspect 2: The method of Aspect 1, wherein the direct C2 connection is a PC5 connection.

Aspect 3: The method of any of Aspects 1-2, wherein the mobility management procedure includes an uncrewed aerial system (UAS) service supplier UAV authorization and authentication mobility management (UUAA-MM) procedure.

Aspect 4: The method of any of Aspects 1-3, wherein the C2 authorization payload is a C2 aviation payload that indicates that the authorization is for the direct C2 connection.

Aspect 5: The method of any of Aspects 1-4, wherein the request message includes a destination address for an authorization server.

Aspect 6: The method of any of Aspects 1-5, wherein the C2 authorization payload includes C2 pairing information for the direct C2 connection.

Aspect 7: The method of any of Aspects 1-6, wherein the response message indicates a successful authorization of the direct C2 connection and includes an application layer identifier.

Aspect 8: The method of any of Aspects 1-7, further comprising: transmitting an updated request message with an updated C2 authorization payload; and receiving an updated response message that indicates whether the direct C2 connection between the UAV and the controller is still authorized or is reauthorized.

Aspect 9: A method of wireless communication performed by a network entity, comprising: receiving a request message associated with a mobility management procedure, the request message including a command and control (C2) authorization payload associated with authorizing a direct C2 connection between an uncrewed aerial vehicle (UAV) and a controller; and transmitting a response message, as part of the mobility management procedure, that indicates whether the direct C2 connection between the UAV and the controller is authorized.

Aspect 10: The method of Aspect 9, wherein the direct C2 connection is a PC5 connection.

Aspect 11: The method of any of Aspects 9-10, wherein the C2 authorization payload is a C2 aviation payload that indicates that the authorization is for the direct C2 connection.

Aspect 12: The method of any of Aspects 9-11, wherein the C2 authorization payload includes C2 pairing information for the direct C2 connection.

Aspect 13: The method of any of Aspects 9-12, wherein the response message indicates a successful authorization of the direct C2 connection and includes an application layer identifier.

Aspect 14: The method of any of Aspects 9-13, further comprising: forwarding the request message to an uncrewed aerial system traffic management (UTM) component; and receiving an authorization response from the UTM.

Aspect 15: The method of any of Aspects 9-14, wherein the request message includes a destination address for an authorization server, and wherein the method comprises: forwarding the request message to the authorization server; and receiving an authorization response from the authorization server.

Aspect 16: The method of any of Aspects 9-15, wherein transmitting the response message includes transmitting the response to a user equipment at the UAV via an access and mobility management function (AMF).

Aspect 17: The method of any of Aspects 9-16, further comprising: receiving an updated request message with an updated C2 authorization payload; and transmitting an updated response message that indicates whether the direct C2 connection between the UAV and the controller is still authorized or is reauthorized.

Aspect 18: The method of any of Aspects 9-17, wherein the network entity includes an uncrewed aerial system network function (UAS NF).

Aspect 19: An apparatus for wireless communication at a device, comprising a processor; memory coupled with the processor; and instructions stored in the memory and executable by the processor to cause the apparatus to perform the method of one or more of Aspects 1-18.

Aspect 20: A device for wireless communication, comprising a memory and one or more processors coupled to the memory, the one or more processors configured to perform the method of one or more of Aspects 1-18.

Aspect 21: An apparatus for wireless communication, comprising at least one means for performing the method of one or more of Aspects 1-18.

Aspect 22: A non-transitory computer-readable medium storing code for wireless communication, the code comprising instructions executable by a processor to perform the method of one or more of Aspects 1-18.

Aspect 23: A non-transitory computer-readable medium storing a set of instructions for wireless communication, the set of instructions comprising one or more instructions that, when executed by one or more processors of a device, cause the device to perform the method of one or more of Aspects 1-18.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A user equipment (UE) at an uncrewed aerial vehicle (UAV) or an aerial UE for wireless communication, comprising:
one or more memories; and
one or more processors, coupled to the one or more memories, configured to:
transmit a request message associated with a mobility management procedure, the request message including a command and control (C2) authorization payload associated with authorizing a direct C2 connection between the UAV and a controller; and
receive a response message, as part of the mobility management procedure, that indicates whether the direct C2 connection between the UAV and the controller is authorized.

2. The UE of claim 1, wherein the direct C2 connection is a PC5 connection.

3. The UE of claim 1, wherein the mobility management procedure includes an uncrewed aerial system (UAS) service supplier UAV authorization and authentication mobility management (UUAA-MM) procedure.

4. The UE of claim 1, wherein the C2 authorization payload is a C2 aviation payload that indicates that the authorization is for the direct C2 connection.

5. The UE of claim 1, wherein the request message includes a destination address for an authorization server.

6. The UE of claim 1, wherein the C2 authorization payload includes C2 pairing information for the direct C2 connection.

7. The UE of claim 1, wherein the response message indicates a successful authorization of the direct C2 connection and includes an application layer identifier.

8. The UE of claim 1, wherein the one or more processors are configured to:
transmit an updated request message with an updated C2 authorization payload; and
receive an updated response message that indicates whether the direct C2 connection between the UAV and the controller is still authorized or is reauthorized.

9. A network entity for wireless communication, comprising:
one or more memories; and
one or more processors, coupled to the one or more memories, configured to:
receive a request message associated with a mobility management procedure, the request message including a command and control (C2) authorization payload associated with authorizing a direct C2 connection between an uncrewed aerial vehicle (UAV) and a controller; and
transmit a response message, as part of the mobility management procedure, that indicates whether the direct C2 connection between the UAV and the controller is authorized.

10. The network entity of claim 9, wherein the direct C2 connection is a PC5 connection.

11. The network entity of claim 9, wherein the C2 authorization payload is a C2 aviation payload that indicates that the authorization is for the direct C2 connection.

12. The network entity of claim 9, wherein the C2 authorization payload includes C2 pairing information for the direct C2 connection.

13. The network entity of claim 9, wherein the response message indicates a successful authorization of the direct C2 connection and includes an application layer identifier.

14. The network entity of claim 9, wherein the one or more processors are configured to:
forward the request message to an uncrewed aerial system traffic management (UTM) component; and
receive an authorization response from the UTM.

15. The network entity of claim 9, wherein the request message includes a destination address for an authorization server, and wherein the one or more processors are configured to:
forward the request message to the authorization server; and
receive an authorization response from the authorization server.

16. The network entity of claim 9, wherein the one or more processors, to transmit the response message, are configured to transmit the response to a user equipment at the UAV via an access and mobility management function (AMF).

17. The network entity of claim 9, wherein the one or more processors are configured to:
receive an updated request message with an updated C2 authorization payload; and
transmit an updated response message that indicates whether the direct C2 connection between the UAV and the controller is still authorized or is reauthorized.

18. The network entity of claim 9, wherein the network entity includes an uncrewed aerial system network function (UAS NF).

19. A method of wireless communication performed by a user equipment (UE) at an uncrewed aerial vehicle (UAV) or an aerial UE, comprising:
transmitting a request message associated with a mobility management procedure, the request message including a command and control (C2) authorization payload associated with authorizing a direct C2 connection between the UAV and a controller; and
receiving a response message, as part of the mobility management procedure, that indicates whether the direct C2 connection between the UAV and the controller is authorized.

20. The method of claim 19, wherein the C2 authorization payload is a C2 aviation payload that indicates that the authorization is for the direct C2 connection.

21. The method of claim 19, wherein the request message includes a destination address for an authorization server.

22. The method of claim 19, wherein the C2 authorization payload includes C2 pairing information for the direct C2 connection.

23. The method of claim 19, wherein the response message indicates a successful authorization of the direct C2 connection and includes an application layer identifier.

24. The method of claim 19, further comprising:
transmitting an updated request message with an updated C2 authorization payload; and
receiving an updated response message that indicates whether the direct C2 connection between the UAV and the controller is still authorized or is reauthorized.

25. A method of wireless communication performed by a network entity, comprising:
receiving a request message associated with a mobility management procedure, the request message including a command and control (C2) authorization payload associated with authorizing a direct C2 connection between an uncrewed aerial vehicle (UAV) and a controller; and
transmitting a response message, as part of the mobility management procedure, that indicates whether the direct C2 connection between the UAV and the controller is authorized.

26. The method of claim 25, wherein the response message indicates a successful authorization of the direct C2 connection and includes an application layer identifier.

27. The method of claim 25, further comprising:
forwarding the request message to an uncrewed aerial system traffic management (UTM) component; and
receiving an authorization response from the UTM.

28. The method of claim 25, wherein the request message includes a destination address for an authorization server, and wherein the method comprises:
forwarding the request message to the authorization server; and
receiving an authorization response from the authorization server.

29. The method of claim 25, wherein transmitting the response message includes transmitting the response to a user equipment at the UAV via an access and mobility management function (AMF).

30. The method of claim 25, wherein the network entity includes an uncrewed aerial system network function (UAS NF).
